(19) United States
(12) Patent Application Publication
(10) Pub. No.: US 2008/0243900 A1
(43) Pub. Date: Oct. 2, 2008

(54) Dynamic and Real-Time Discovery of Computing Resources

(75) Inventors: Guy Yohanan, Lehavim (IL); Jay Hahn-Steichen, Portland, OR (US)

Correspondence Address: GROSSMAN, TUCKER, PERREAULT & PFLEGER, PLLC;C/O Intellevate, LLC, P. O. BOX 52050, MINNEAPOLIS, MN, 55402, US

(73) Assignee: INTEL CORPORATION, Santa Clara, CA (US)

(21) Appl. No.: 11/694,265

(22) Filed: Mar. 30, 2007

(51) Int. Cl. G06F 17/00

(52) U.S. Cl. 707/102; 707/E17.005

(57) ABSTRACT

The disclosure is a real-time, dynamic and automatic system for computing object discovery within an IT enterprise network. Every time an object is activated on the network, the activation is self-announced by the object sending a thin ‘hello’ message to a network manager. The ‘hello’ message includes the minimum identification and addressing information for the object, including the objects Uniform Resource Identifier, allowing the manager to thereby discover the object. The manager then uses the object'Uniform Resource Identifier to query the object for configuration information from its catalog, which is exposed through the object'end-points. The manager then registers the discovered object instance and its associated data in a configuration management database. The process is based on industry-open Web Services technologies and standards to simplify enterprise integration.

### FIELD

The present disclosure is related to the recognition of and adaptation to additions of managed-objects on a computer or network.

### BACKGROUND

In the context of IT enterprise management, a “managed-object” may be any computing object, at any layer, and in any level, that composes the enterprise'computing landscape. That includes any software, firmware or hardware components. Examples of the introduction or modification of a managed-object include such activities as the addition of a computer, device or printers to a network (in which case the device can be related as a managed-object, and any software or hardware components on it can be related as managed-objects), the installation of new software to a computer on the network, or the reconfiguration of an existing application on a computer on the network.

Anything added or modified within the computer (for instance) on the network, from the hardware layer through the operating system layer to the application layer, would be considered a managed-object, if required to be managed. This applies for systems including servers, storage, wired networks, mobile networks, small form factor devices, and other computing systems.

The vision of an “autonomic enterprise” includes computing capabilities that support an enterprise yet which function independently of the enterprise. They must be well-integrated, must be self-maintaining, and must control their own resources to deliver IT services in a consistent and continuous way. Such is part of an “Agile IT” vision, allowing an IT operation to continuously and automatically re-adjust in a dynamic and automatic way, in response to changing business needs.

One complexity hindering the development of a fully autonomic enterprise lies in the fact that the different components and systems in existing enterprises have used different protocols for communication within the same domain, and are usually proprietary, resulting in immense integration efforts. Lacking a common language has made enterprise components and systems undiscoverable in an automatic sense, and denied them the ability to freely communicate with each other.

Discovery is the capability of a network to discover any computing object on the network as it joins the network or changes its state (for example going online or offline), and the recognition of any relevant data regarding that object (such as the object'metadata), including the object'functionality, characteristics, attributes and it'linkage to other objects.

Discovery is a fundamental capability for enterprise manageability and the evolution of the autonomic enterprise and agile Information Technology (IT) visions. Ideally, discovery would be done in real-time so the right decisions and actions can be made at the IT services level, and therefore would be automatic and dynamic. The nature of the ever-growing, ever-changing and highly dynamic enterprise computing landscape calls for a very strong and simple discovery mechanism, so computing objects can be discovered and controlled in real-time to enable IT services in a company'ever-growing and ever-changing business needs. In an ideal enterprise computing framework, with hundreds of millions of objects, the discovery process for a given object would start within the object itself to achieve the timeliness required.

There are presently no effective means for real-time, dynamic & automatic managed-object discovery within enterprise IT management systems. Means that do exist for managed-object discovery apply only to limited domains, and are implemented either manually or by proprietary methods that do not offer the capabilities needed for many applications. Most of the existing advanced means use a “pull” mode to scan the environment, which ends up being a lengthy and resource-consuming process, achieving only partial results, and does not provide accurate data in a configuration management database because the data changes faster than the scanning process.

Some solutions exist for Universal Plug and Play (UPNP) and its successors, such as Service Location Protocol (SLP), however those forms of discovery are focused on services discovery, which aim to find an available service for a client. Such methods of discovery are not adequate for system management in the enterprise, and do not provide the required capability for computing object discovery within an enterprise manageability framework.

Additionally, existing tools do not provide the level of object discovery granularity needed, as they may discover a system (and maybe its main component) but not the entire set of objects composing that system, including the smallest hardware components or low level software processes. Moreover, existing tools do not provide the entire set of information about the object needed in the enterprise management framework.

### BRIEF DESCRIPTION OF THE DRAWINGS

FIG. 1 is a schematic diagram of a Web Services Management stack in front of each component to create a common language,

FIG. 2 is a schematic diagram of the managed-object discovery process,

FIG. 3 is a diagram showing a logical rendering of the parts of the Configuration Management Database (CMDB), and the relation of its parts to other automation processes,

FIG. 4 is a code string for an announcement message of the first step of the managed-object discovery process,

FIG. 5 is a code string used in a “Transfer Get” request for detailed information, being the second step of the managed-object discovery process,

FIG. 6 is a code string which is a response to the message of FIG. 5, being the second step of the managed-object discovery process,

FIG. 7 is a code string for an announcement message where the announcement is a departure of an object that has been under management from the managed network.

### DETAILED DESCRIPTION

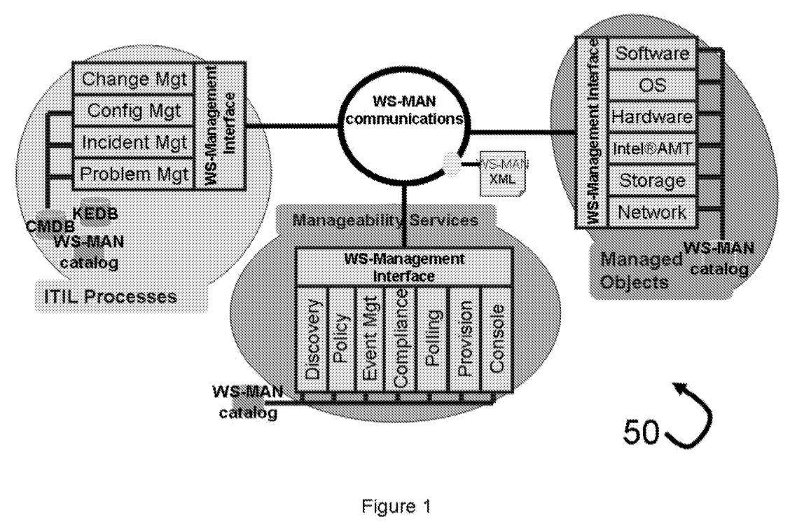

A system for real-time, dynamic and automatic managed-object discovery within an enterprise IT management system is described below, with reference to FIGS. 1 through 7. A common language, as disclosed herein, makes enterprise components and systems automatically discoverable and enables them to freely communicate with each other.

Referring to FIG. 1, the present disclosure demonstrates a behavior using the Web Services Management (WS-Man) protocol stack 50, in front of each one of the stack layers, components and systems in the enterprise in a reusable fashion. The WS-Man standard communications protocol (SOAP\XML) may be used for communications between the different components participating in the discovery process described below. WS-Man enables a standard, common and unified messaging layer, and it provides the framework in which the managed-object discovery behavior described here can be accomplished.

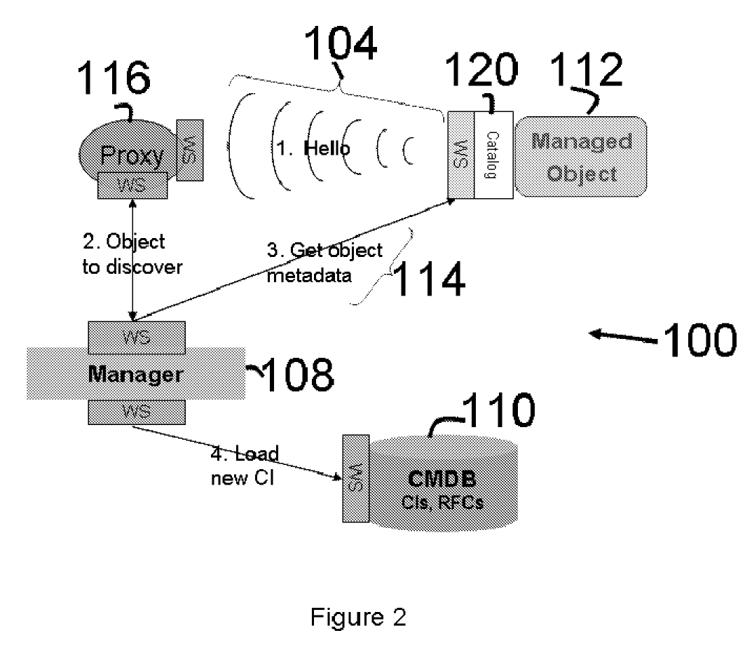

One factor in the evolution of the autonomic enterprise by the present disclosure is the ability to discover dynamically all computing resources and immediately control them. FIG. 2 provides a schematic representation of dynamic real-time discovery process 100, starting with a self-announcing “hello” message 104 as managed-object 112 joins the network, and continuing through the following process. The managed-object 112 in this case is a computing resource. Dynamic, real-time discovery of the present disclosure provides the ability for the network to know when a managed-object 112 is activated on the network or changes its state, the ability to query the managed-object 112 for its metadata, and the registration of the new or altered managed-object in a Configuration Management Database (CMDB) 110.

The dynamic, real-time managed-object discovery process 100 has four main operations:

1) As the managed-object 112 is activated on the network, it announces itself by sending a “Hello” message 104.

2) The manager 108 receives the announcement and queries 114 the managed-object end-points (through a manageability interface) for the object configuration item (CI) information.

3) The manager 108 then registers the managed-object 112 in the Configuration Management Database (CMDB) 110.

4) The managed-object 112 has a controlled removal from the network, sending a “Bye” message causing the CMDB 110 to modify the current operational state of the object 112.

Examples of object activation include;

1) Adding a server to a network;

2) Loading and configuring software on a server;

3) Either stopping or restarting a software service.

Essentially, whenever a managed object changes state it should be able to send a message. In this disclosure, code is used to identify these events from information made available by the Operating System. When these state change events occur, the code sends a corresponding “hello” message or “bye” message.

There are many and various means by which all object activations may be performed. The method of communication may vary for hardware, operating system, and software running in an operating system. The present disclosure anticipates a reliable common framework to which all computing objects conform; each object using some means to announce itself following the pattern described herein when it is activated or deactivated.

One aspect of this process is that the managed-object 112 becomes part of its own manageability. Another aspect is that self-announcement may apply to objects at all layers in the stack, and all objects in each layer.

The announcement process may be implemented through multicast or unicast, using an address. In the multicast case, a reference to the Discovery Proxy (DP) 116 address may be part of the WS stack implementation. In the unicast case, the DP address may be delivered as part of the initial provisioning of the system, or the managed-object 112 end-point could get the DP address when doing initialization. For example, an address may be provided via Dynamic Host Configuration Protocol (DHCP).

The hello message 104 is sent to this network address using a protocol appropriate to the domain in which the object operates. A single common protocol may not be appropriate for all domains—for example, networking devices may communicate to one well-known discovery end-point using User Datagram Protocol (UDP), while applications may communicate via hypertext transfer protocol (HTTP) to a different end-point.

The network for implementation of the managed-object discovery system 100 is schematically diagrammed in FIG. 2, and is based on industry-open standard web services technologies to simplify enterprise integration and promote the evolution of an autonomic enterprise. Specifically, the specifications used to implement this discovery process 100 include Web Services for Management (WS-Man) and Web Services Dynamic Discovery (WS-Discovery).

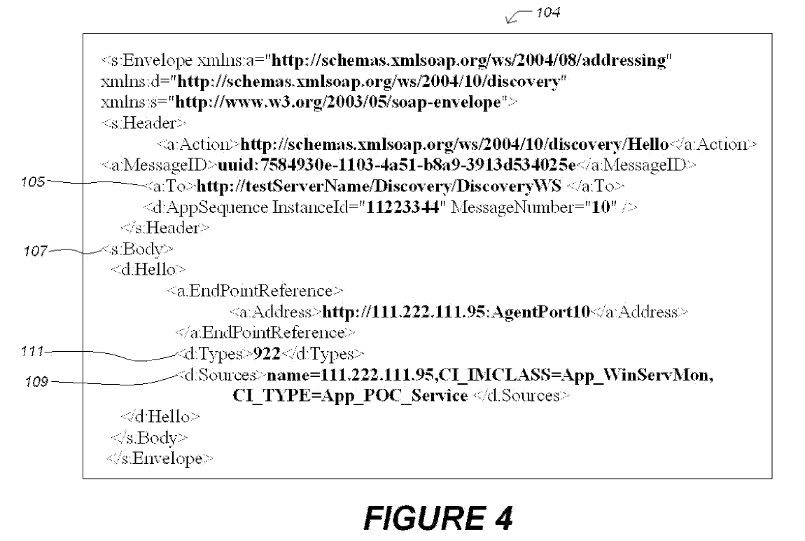

The content of a “hello” message according to the disclosure is shown in FIG. 4. The message 104 essentially follows the WS-Discovery specification in its format. The “To” tag 105 in the header indicates where this message is being sent—that is, the well-known address. The other parts of interest are within the “Body” tag 107. First is the address to be used in step 2 of discovery—collect more details on the object announced in this hello message at the Address in this tag. This address could be the address of a proxy, so it may differ from the “name=” value found at the Sources tag 109.

The “Type” tag 111 is used to hold a reference to the instance, if instances are warranted. For example, a Windows® service may run in multiple instances. In this case, Type would be used to pass the PID of the instance.

The “Sources” tag 109 is used to hold the name elements that permit automated understanding of what object is being reference. The information contained in tag 109 may vary by objective type, and thus, this tag may be tied to a taxonomy. These elements may provide a natural key to the object. In the present case, a three part identity was developed, relying on a taxonomy of category, where:

name=<indication of where this object resides>,
object category=<a class of object>,
object type=<an instance of class>

Ideally, data in the Hello message 104 would be constrained to an industry standard format and taxonomy. DMTF organization'CIM format may be used in some cases to provide a data structure and to specify required content for introduction of any new or modified manageable object.

As the managed-object (MO) 112 joins the network or has a metadata change it sends an announcement in the form of the thin “Hello” message 104 of FIG. 2 to a Discovery Proxy (DP) 116 that is responsible for receiving those announcements and forwarding them to the manager (an enterprise level system) 108.

It is anticipated that proxies will be deployed as needed in the enterprise—and this need will vary with the size and complexity of the enterprise. Each of the deployed proxies will provide a target for messages to the well-known address within the boundaries established for it by network configuration.

Logic policies may also be included in the Discovery Proxy to help determine classes of managed-objects. In this way the DP acts as a filter. These policies may also enforce the granularity of data which it is desirable to maintain. For instance; when the “Hello” message is received by the DP for a class of object of certain interest, the subsequent interrogation for data about the object may be either course-grained or fine-grained. Not all hello messages pass this initial filter step. If the hello message passes this initial filter it is passed to the Manager 108.

The Discovery Proxy 116 is equipped with a primary manager address and a secondary Manager address. DP 116 may send a unicast message to the manager 108 with the newly discovered managed-object 112. The Manager may include an implementation of DP 116.

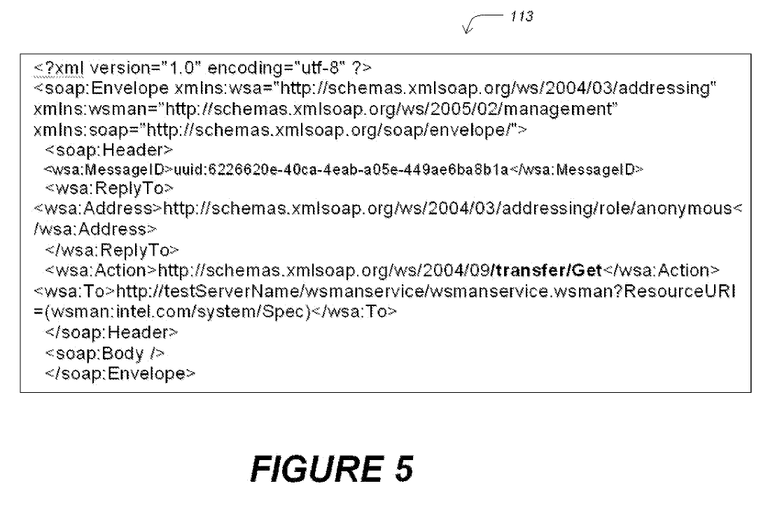

The manager 108 then resolves the managed-object end-point Uniform Resource Identifier (URI) representing its manageability interface, which was provided in the thin “Hello” message 104. The manager 108 then sends the “Get Transfer” query 113 in FIG. 5 to the managed-object 112, requesting more information as needed for enterprise management. WS-Transfer, which is part of WS-Man specification suite, is then used to define the format, content and request orchestration for this request. The present disclosure follows the WS-Man specification for such web services—accepting a WS-Transfer “Get” instruction for producing simple request/reply results, as shown in FIG. 5.

Where available, use is made of a catalog in WS-Man catalog format. For ease of implementation a simple catalog may be created for each managed-object, which may satisfy the need for data directly from the catalog for that particular object. The managed-object catalog 120, which is part of the WS-Man specification, contains the information used by the manager 108 to pull all required data, such as the events exposed by the managed-object 112, the methods available and how they can be used, and the managed-object properties and attributes. The data in the managed-object catalog is preferably created when a managed-object is installed, or may be kept updated by local operating system audit/inventory capability.

The WS-Man catalog 120 enables the query of FIG. 5, the second operation in the discovery process. Catalog 120 is the entire set of metadata available from a WS-Man agent for a given resource. Catalog 120 contains definitions of the manageability interface of managed objects 112, and the data model for its metadata. It allows dynamically querying of the managed-object 112 for the information and methods the object 112 exposes and defines how to use them in a loosely-coupled fashion.

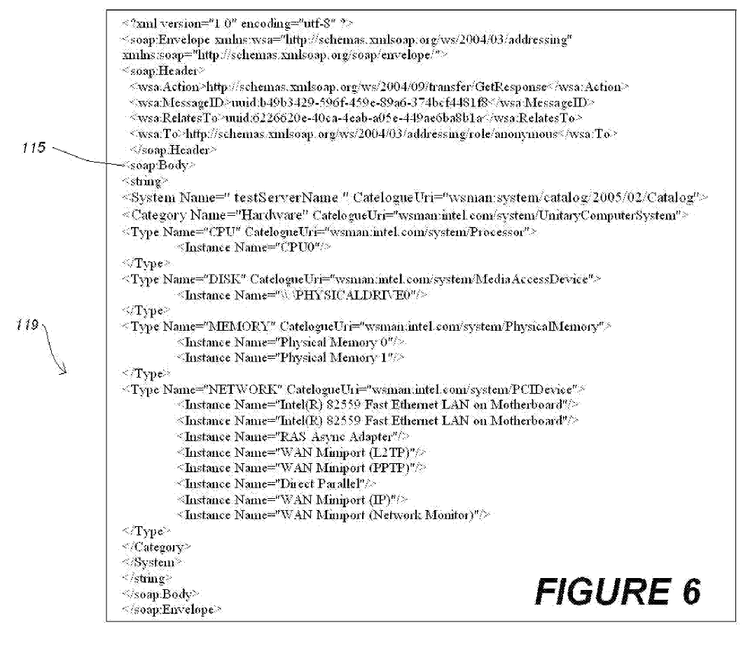

Operating system enabled data lookups, such as Windows® WMI queries, are also provided through the web service interface for objects where the catalog data may be insufficient. Referring to FIG. 6, the result is formatted according to the WS-Transfer specification. Where available, data associated with the “Body” tag 115 of the result is formatted using a CIM (dmtf.org) schema for the object. Where such a schema was not readily available, a string of pertinent data may simply be passed back with appropriate tags, such as the reply 119 of FIG. 6 to the transfer “get” message 113 of FIG. 5.

CMDB 110 may include web services for Configuration Item (CI) lookup, add, and update functions. Lookup may be processed first, and if the record is new, the manager would then invoke the CMDB “add” service. If the record existed, it would invoke the CMDB “update” service. The CMDB is meant to represent a single logical entity. Its implementation could be as a single physical database, but in large enterprises it is more likely to require an implementation in which it is a ubiquitous directory of all objects and their states.

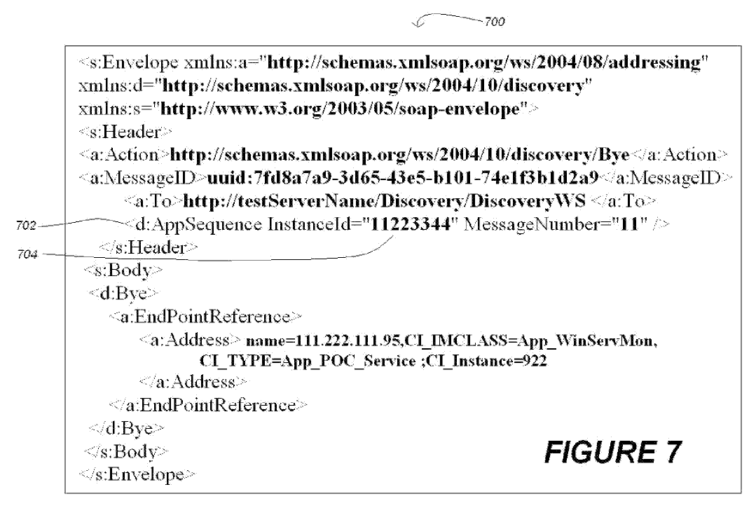

The capability used for tracking changes from an available to an unavailable state involved the use of the same sensors based on status data available in the operating system regarding a hardware component or a software installation. When the managed-object became unavailable, a “bye” message may be sent out, such as that shown in FIG. 7. Another possible implementation, not relying on sensors, would be to have the “start”, “stop”, “install” and “de-install” mechanisms for every object implement the self-announcement behavior.

Referring now to the “bye” message 700 shown in FIG. 7, the “AppSequence” tag 702 creates a sort of long-duration transaction. “Instance” ID 704 has been set up by the “hello” message 104 previously disclosed, which numbers the transactions within that instance. IN this example, “hello” message 104 had a number of “10”, so “bye” message 700 has a number of “11”. This is one way of tracking a history of action taken within a single object'life-span.

Alternatively, the simple existence of a “bye” message may be sufficient for providing the life-stage of the object. To ensure a change of state to the same object, the same “Type” and “Sources” information may be sent with the corresponding “hello” message.

“Bye” message 700 is sent from the managed-object 112 to proxy 116 in the same manner as the “hello” message 104. The proxy forwards message 700 to manager 108 and the manager invokes the update service at CMDB 110 to change the state of the object as appropriate.

Such dynamic, automatic, real-time managed-object discovery as exemplified herein is an essential capability for fully functional enterprise manageability as it evolves toward a fully autonomic framework. Such discovery addresses all layers of the stack, including hardware, the virtual machine monitor (VMM), operating systems, and applications. It is not limited to devices only.

Because such discovery is dynamic, automatic, and real-time (triggered when the managed-object changes state) it enables an accurate picture of the state of the enterprise infrastructure and its services at any point in time so that the right IT business decisions can be made.

The system and process above demonstrate a common and standard communications protocol and a standard and discoverable interface type. These permit abstraction of the specifics and details of enterprise components, systems, utilities, and IT business processes.

Each of these elements is able to communicate freely and discover each other using a common protocol, providing true enterprise level autonomic behavior in which low level objects and technologies track their own availability and location.

Some of the more detailed benefits of this system and process include;

1) The ability to successfully interface existing manageability processes, services, toolsets, and the various managed objects with a reusable WS-Management protocol stack.

2) Minimization of the effort required for such interfacing—more time is spent increasing the flexibility of the stack than in creating the functionality.

3) Use of the SOAP protocol to do automated self-announcement of a device as it is introduced to the network.

4) Use of the same methodology to demonstrate self-announcement of additions or changes to software on the device.

5) Self-announcement integration with automatic end-point interrogation over WS-Management; and successful use of WS-Management to automatically populate a CMDB with the data gathered through interrogation.

6) Utilization of the WS-Catalog to represent and expose the managed-object metadata in a standard way to drive standards-based and free communications between components in a loosely-coupled manner.

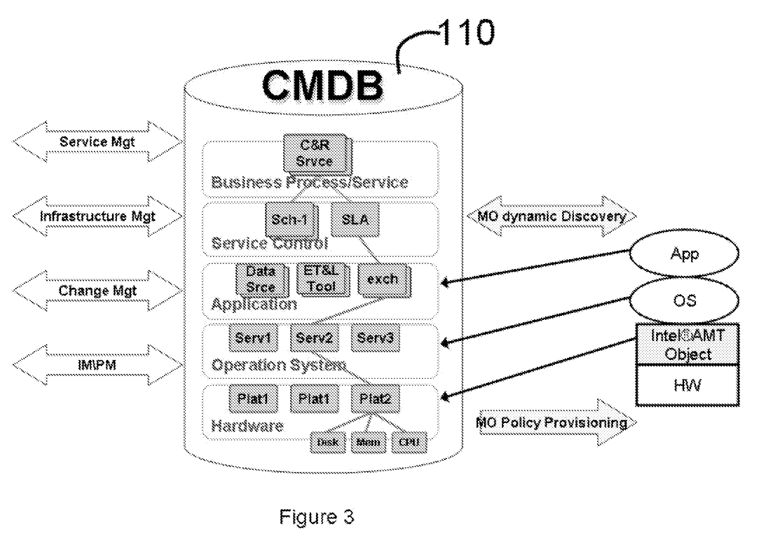

The process is dynamic, automatic and operates in real-time. It is an end-to-end discovery process which includes interface and information exposed discovery, as well as configuration management database registration. It enables the building of a relationship among different managed-object, as shown in FIG. 3. Additionally, the data in configuration management database is always accurate and representative of the current real-world situation.

It should be understood that the above disclosures are merely representative and that there are many possible embodiments of this managed-object discovery, and that the scope of the invention should only be limited according to the following claims made thereto.

What is claimed is;

1. A method for dynamic, automatic and real-time managed-object discovery in an enterprise network comprising:
sending an activation announcement message from a managed-object to a network manager;
sending a query from said network manager requesting endpoints which comprise configuration item information of said managed-object; and
registering said managed-object and said configuration item information in a configuration management database.

2. The method of claim 1 wherein said query is sent to a managed-object catalog comprising said endpoints.

3. The method of claim 2 wherein said managed-object catalog is configured according to Web Services for Management specifications.

4. The method of claim 3 wherein said configuration item information is from the group including:
events exposed by said managed-object;
methods available from said managed-object;
uses for said methods available from said managed-object;
properties of said managed-object;
attributes of said managed-object; and
dependency information of said managed-object with another object.

5. The method of claim 1 wherein said query is sent through a manageability interface which is based on Web Services for Management specifications.

6. The method of claim 1 wherein said registering said managed-object comprises creating a new configuration item in said configuration management database when said managed-object is a new object instance.

7. The discovery method of claim 1 wherein said registering said managed-object comprises updating an existing configuration item in said configuration management database when said managed-object is an existing object instance.

8. The method of claim 7 wherein said updating comprises registering an object status change between “offline” and “online”.

9. The discovery method of claim 1 wherein said activation announcement message comprises a reference to a discovery proxy address.

10. The method of claim 9 wherein said discovery proxy address is comprised in a stack implementation which is based on Web Services for Management specifications.

11. The method of claim 1 wherein the enterprise network comprises a discovery proxy address, said activation announcement message is unicasted, and said query requests said discovery proxy address.

12. The method of claim 1 wherein the said activation announcement message comprises an end-point address and basic identification information of said managed-object.

13. A method for dynamic, automatic and real-time managed-object discovery in an enterprise network comprising:
sending an activation announcement message from a managed-object to a network manager;
sending a query from said network manager through a manageability interface requesting endpoints which comprise configuration item information of said managed-object from a managed object catalogue which is configured according to Web Services for Management specifications; and
registering said managed-object in a configuration management database by either creating a new configuration item in said configuration management database when said managed-object is a new object instance or updating an existing configuration item in said configuration management database when said managed-object is an existing object instance.

14. The method of claim 13 wherein said configuration item information is from the group including:
events exposed by said managed-object;
methods available from said managed-object;
uses for said methods available from said managed-object;
properties of said managed-object;
attributes of said managed-object; and
dependency information of said managed-object with another object.

15. The method of claim 13 wherein said manageability interface is based on Web Services for Management specifications.

16. The method of claim 13 wherein said updating comprises registering an object status change between “offline” and “online”.

17. The discovery method of claim 13 wherein said activation announcement message comprises a reference to a discovery proxy address.

18. The method of claim 17 wherein said discovery proxy address is comprised in a stack implementation which is based on Web Services for Management specifications.

19. The method of claim 13 wherein the enterprise network comprises a discovery proxy address, said activation announcement message is unicasted, and said query requests said discovery proxy address.

20. The method of claim 13 wherein the said activation announcement message comprises an end-point address and basic identification information of said managed-object.
